(19) United States
(12) Patent Application Publication
(10) Pub. No.: US 2021/0263610 A1
(43) Pub. Date: Aug. 26, 2021

(54) TOUCHPAD MODULE AND COMPUTING DEVICE USING SAME

(71) Applicant: Primax Electronics Ltd., Taipei (TW)

(72) Inventors: Wei-Wen Yang, Taipei (TW); Tai-Sou Huang, Taipei (TW)

(21) Appl. No.: 16/863,054

(22) Filed: Apr. 30, 2020

(30) Foreign Application Priority Data
Feb. 21, 2020 (TW) 109105718

(51) Int. Cl. G06F 3/041; H01H 13/702; G06F 3/01; G06F 1/16

(52) U.S. Cl. CPC G06F 3/0416; H01H 13/702; G06F 1/1616; G06F 1/169; H01H 2239/074; G06F 3/016

(57) ABSTRACT

A touchpad module includes a bracket, a touch member and a supporting assembly. The touch member is located over the bracket. The touch member includes a membrane wiring board and a circuit board. The circuit board is located over the membrane wiring board. The supporting assembly is arranged between a second end of the touch member and the bracket. While a first end of the touch member is pressed down, the first end of the touch member is swung relative to the bracket. Consequently, a membrane switch of the membrane wiring board is triggered. The present invention further provides a computing device with the touchpad module.

### FIELD OF THE INVENTION

The present invention relates to an input device, and more particularly to an input device with a touch control function.

### BACKGROUND OF THE INVENTION

With increasing development of science and technology, a variety of electronic devices are designed in views of convenience and user-friendliness. For helping the user well operate the electronic devices, the electronic devices are gradually developed in views of humanization. The common electronic devices include for example notebook computers, mobile phones, satellite navigation devices, or the like. Recently, the storage capacity and the processor's computing performance for these electronic devices are largely enhanced, and thus their functions become more powerful and complicated. For efficiently operating an electronic device, a touchpad is used as an input device of the electronic device for controlling the operations of the electronic device.

FIG. 1 schematically illustrates a conventional notebook computer with a touchpad module. As shown in FIG. 1, the touchpad module 1 is installed on a casing 21 of the notebook computer 2. Moreover, at least a portion of the touchpad module 1 is exposed outside so as to be touched by the user's finger. Consequently, the user may operate the touchpad module 1 to control the notebook computer 2. For example, in case that the user's finger is placed on the touchpad module 1 and slid on the touchpad module 1, a cursor 23 shown on a display screen 22 of the notebook computer 2 is correspondingly moved. Moreover, in case that the touchpad module 1 is pressed down by the user's finger, the notebook computer 2 executes a specified function. The use of the touchpad module 1 can implement some functions of the conventional mouse. In other words, the user may operate the notebook computer 2 through the touchpad module 1 without the need of additionally carrying or installing the mouse.

FIG. 2 is a schematic cross-sectional view illustrating the touchpad module as shown in FIG. 1, in which the touchpad module is not pressed down. FIG. 3 is a schematic cross-sectional view illustrating the touchpad module as shown in FIG. 2, in which the touchpad module is pressed down. As shown in FIGS. 2 and 3, a fixing frame 24 is concavely formed in the casing 21 of the notebook computer 2. A supporting structure 241 and a triggering part 242 are respectively protruded from two opposite sides of an inner wall of the fixing frame 24. A metal dome switch 13 is located at a first end 11 of the touchpad module 1. A second end 12 of the touchpad module 1 is connected with the supporting structure 241.

When the touchpad module 1 is pressed down by the user, the first end 11 of the touchpad module 1 is swung downwardly relative to the triggering part 242 by using the supporting structure 241 as a fulcrum. As the metal dome switch 13 of the touchpad module 1 is pushed by the triggering part 242 of the fixing frame 24, the metal dome switch 13 is triggered and a click feedback sound is generated. Moreover, after the metal dome switch 13 is triggered, the touchpad module 1 generates a switch control signal to the notebook computer 2. According to the switch control signal, the notebook computer 2 executes a corresponding function.

When the touchpad module 1 is no longer pressed by the user, the first end 11 of the touchpad module 1 is swung upwardly relative to the triggering part 242 in response to an elastic force of the supporting structure 241. Consequently, the touchpad module 1 is returned to its original position.

However, the conventional touchpad module 1 still has some drawbacks. For example, after the touchpad module 1 is pressed down, the travelling distances corresponding to different locations of the touchpad module 1 are different. The different travelling distances corresponding to different locations become hindrance from operating the touchpad module 1. For example, as shown in FIG. 1, the region A and the region B are located at two corners of the touchpad module 1, respectively. Moreover, the region A and the region B are located at two opposite sides of the first end 11 of the touchpad module 1. If one of the region A and the region B is pressed by the user, there is a large difference between the downward travelling distances of the region A and the region B. Under this circumstance, the operating tactile feel is impaired, or even the metal dome switch 13 is unable to be effectively triggered.

For solving the above drawbacks, another conventional touchpad module is equipped with a stabilizer bar. For example, Chinese patent publication No. CN108268179 discloses that the arrangement of the stabilizer bar increases the linking efficacy of the touchpad module after the touchpad module is pressed down. However, the arrangement of the stabilizer bar increases the number of the component parts and the assembling complexity and is detrimental to the overall thickness reduction of the touchpad module.

In other words, the conventional touchpad module and the conventional computing device with the touchpad module need to be further improved.

### SUMMARY OF THE INVENTION

An object of the present invention provides a touchpad module with a membrane wiring board.

Another object of the present invention provides a computing device with the touchpad module.

In accordance with an aspect of the present invention, a touchpad module is provided. The touchpad module includes a bracket, a touch member and a supporting assembly. The touch member is located over the bracket. The touch member includes a membrane wiring board and a circuit board. The membrane wiring board includes at least one membrane switch, and the at least one membrane switch is located at a first end of the touch member. The circuit board is located over the membrane wiring board. The circuit board issues a control signal in response to a touching behavior of a user on the touch member. The supporting assembly is arranged between a second end of the touch member and the bracket. While the first end of the touch member is pressed down, the first end of the touch member is swung relative to the bracket, so that the at least one membrane switch is triggered.

In an embodiment, the touchpad module further includes a haptic sensor between the bracket and the circuit board. When the membrane switch is triggered, the haptic sensor generates a haptic function.

In accordance with another aspect of the present invention, a computing device is provided. The computing device includes a casing, a processor and a touchpad module. An accommodation space is concavely formed in the casing. The processor is disposed within the casing. The touchpad module is disposed within the accommodation space and electrically connected with the processor. The touchpad module includes a bracket, a touch member and a supporting assembly. The touch member is located over the bracket. The touch member includes a membrane wiring board and a circuit board. The membrane wiring board includes at least one membrane switch, and the at least one membrane switch is located at a first end of the touch member. The circuit board is located over the membrane wiring board. The circuit board issues a control signal in response to a touching behavior of a user on the touch member. The supporting assembly is arranged between a second end of the touch member and the bracket. While the first end of the touch member is pressed down, the first end of the touch member is swung relative to the bracket, so that the at least one membrane switch is triggered.

The above objects and advantages of the present invention will become more readily apparent to those ordinarily skilled in the art after reviewing the following detailed description and accompanying drawings, in which:

### BRIEF DESCRIPTION OF THE DRAWINGS

FIG. 1 schematically illustrates a conventional notebook computer with a touchpad module;

FIG. 2 is a schematic cross-sectional view illustrating the touchpad module as shown in FIG. 1, in which the touchpad module is not pressed down;

FIG. 3 is a schematic cross-sectional view illustrating the touchpad module as shown in FIG. 2, in which the touchpad module is pressed down;

FIG. 4 is a schematic perspective view illustrating the outer appearance of a computing device with a touchpad module according to an embodiment of the present invention;

FIG. 5 is a schematic top view illustrating portions of the casing and the touchpad module of the computing device as shown in FIG. 4;

FIG. 6 is a schematic bottom view illustrating portions of the casing and the touchpad module of the computing device as shown in FIG. 4;

FIG. 7 is a schematic cross-sectional view illustrating the touchpad module as shown in FIG. 5;

FIG. 8 is a schematic exploded view illustrating portions of the touchpad module as shown in FIG. 7;

FIG. 9A is a schematic cross-sectional view illustrating a portion of the touchpad module as shown in FIG. 5, in which the touch member of the touchpad module is not pressed down;

FIG. 9B is a schematic cross-sectional view illustrating a portion of the touchpad module as shown in FIG. 5, in which the touch member of the touchpad module is pressed down; and

FIG. 10 schematically illustrates a touchpad module for a computing device according to another embodiment of the present invention.

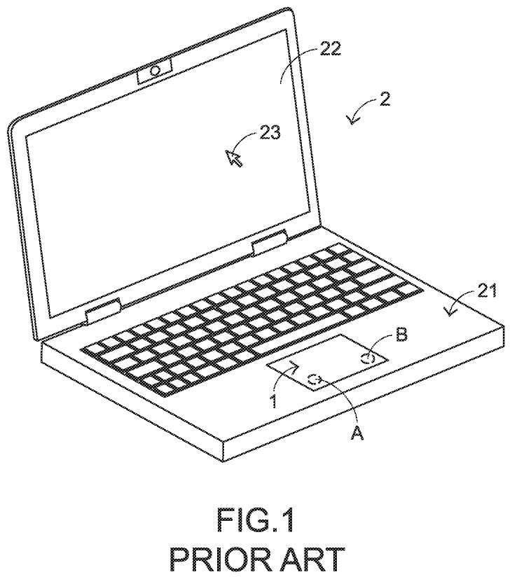

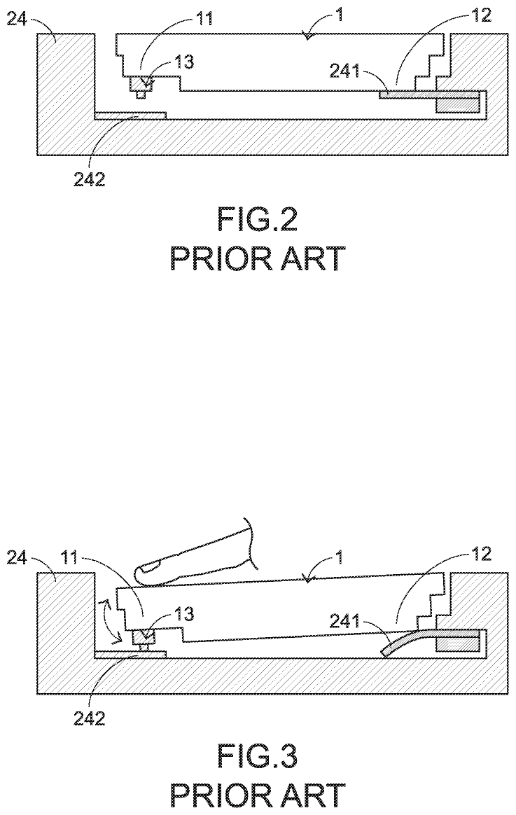

### DETAILED DESCRIPTION OF THE PREFERRED EMBODIMENT

The embodiments of present invention will be described more specifically with reference to the following drawings. Generally, in the drawings and specifications, identical or similar components are designated by identical numeral references. For well understanding the present invention, the elements shown in the drawings are not in scale with the elements of the practical product. In the following embodiments and drawings, the elements irrelevant to the concepts of the present invention or the elements well known to those skilled in the art are omitted. It is noted that numerous modifications and alterations may be made while retaining the teachings of the invention.

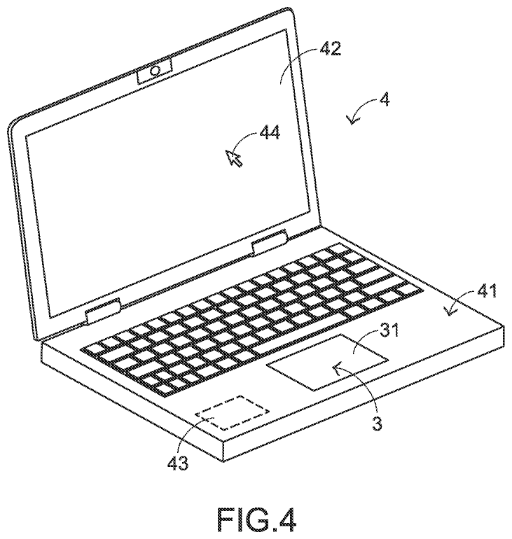

FIG. 4 is a schematic perspective view illustrating the outer appearance of a computing device with a touchpad module according to an embodiment of the present invention. An example of the computing device 4 includes but is not limited to a notebook computer. In an embodiment, the computing device 4 comprises a casing 41, a display screen 42, a processor 43 and a touchpad module 3. Moreover, an accommodation space is concavely formed in the casing 41. The touchpad module 3 is disposed within the accommodation space and electrically connected with the processor 43. Moreover, at least a portion of the touchpad module 3 is exposed outside so as to be touched by the user's finger. Consequently, the user may operate the touchpad module 3 to control the computing device 4. For example, in case that the user's finger is placed on the touchpad module 3 and slid on the touchpad module 3, a cursor 44 shown on the display screen 42 is correspondingly moved. Moreover, in case that the touchpad module 3 is clicked (or pressed) by the user's finger, the computing device 4 executes a specified function.

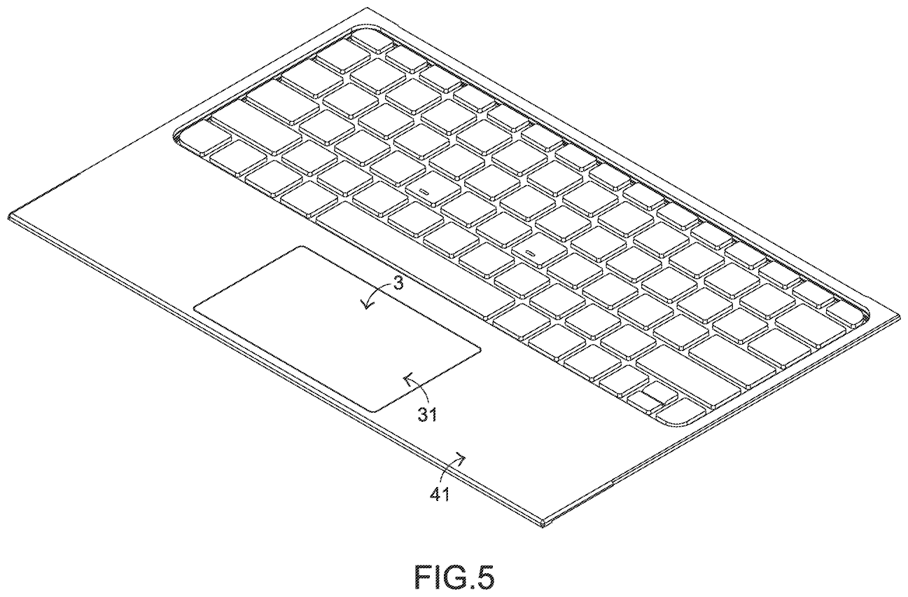

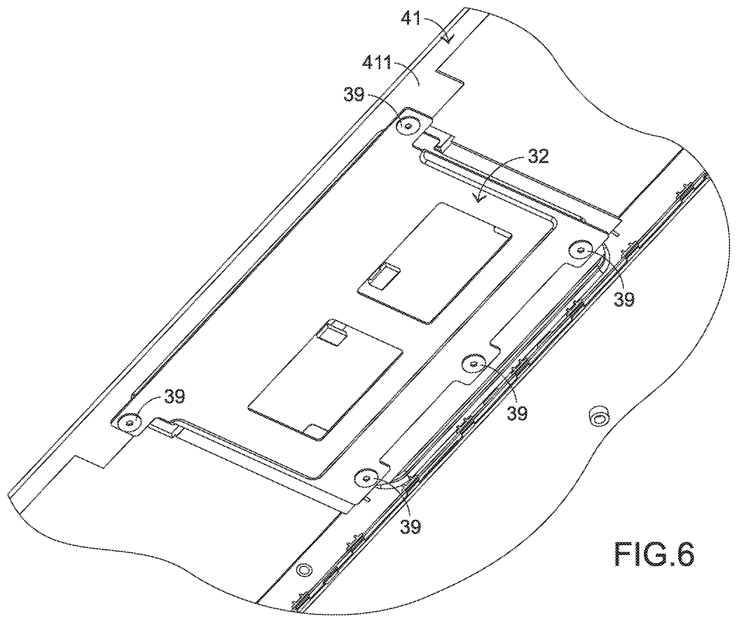

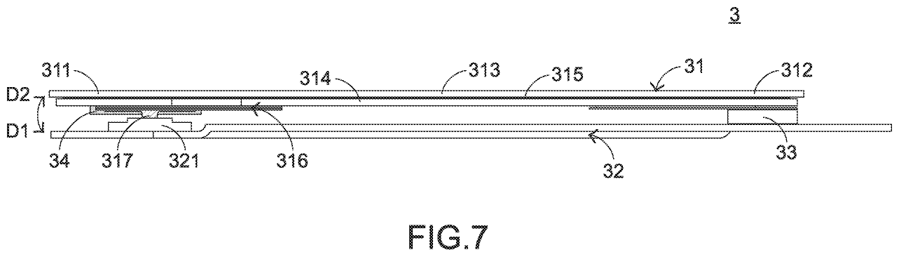

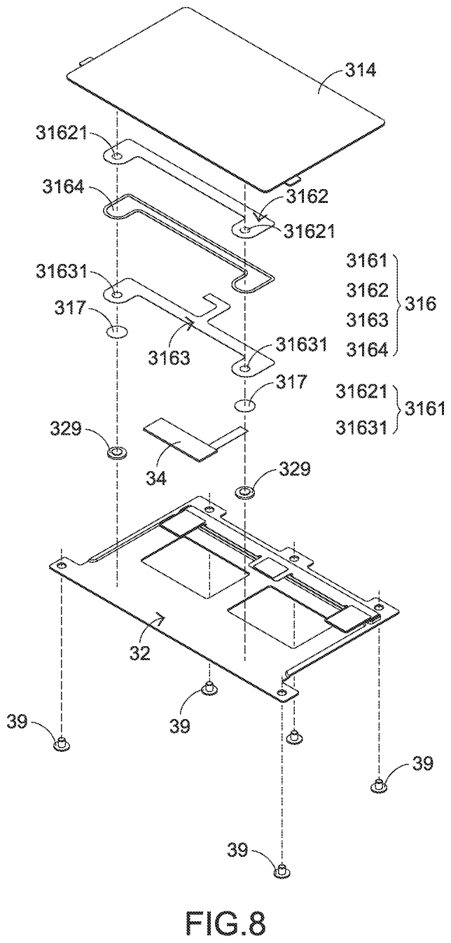

Please refer to FIGS. 5, 6, 7 and 8. FIG. 5 is a schematic top view illustrating portions of the casing and the touchpad module of the computing device as shown in FIG. 4. FIG. 6 is a schematic bottom view illustrating portions of the casing and the touchpad module of the computing device as shown in FIG. 4. FIG. 7 is a schematic cross-sectional view illustrating the touchpad module as shown in FIG. 5. FIG. 8 is a schematic exploded view illustrating portions of the touchpad module as shown in FIG. 7.

The touchpad module 3 comprises a touch member 31, a bracket 32 and a supporting assembly 33. The bracket 32 is located under the touch member 31. Moreover, as shown in FIG. 6, the bracket 32 is fixed on an inner wall 411 of the casing 41 through fastening elements 39 (e.g., screws). The supporting assembly 33 is arranged between a second end 312 of the touch member 31 and the bracket 32. While a first end 311 of the touch member 31 is swung, the supporting assembly 33 is used as a fulcrum. That is, when the first end 311 of the touch member 31 is pressed down, the first end 311 of the touch member 31 is swung relative to the bracket 32 in a first direction D1 (see FIG. 7).

From top to bottom, a covering plate 313, a circuit board 314 and a membrane wiring board 316 of the touch member 31 are sequentially shown. At least a portion of the covering plate 313 is exposed outside the casing 41. The membrane wiring board 316 is electrically connected with the circuit board 314. The membrane wiring board 316 comprises two membrane switches 3161. The two membrane switches 3161 are located at two opposite sides of a first end 311 of the touch member 31, respectively. When the circuit board 314 senses the touching behavior of the user on the touch member 31, the circuit board 314 issues a corresponding control signal. For example, when the circuit board 314 senses a sliding behavior of the user on the covering plate 313, the circuit board 314 issues a displacement control signal. Alternatively, when the circuit board 314 senses that the user presses the covering plate 313 to trigger the membrane switches 3161, the circuit board 314 issues a switch control signal. According to the control signal, the computing device 4 executes a corresponding command. Preferably but not exclusively, the covering plate 313 and the circuit board 314 are combined together through an adhesive layer 315, the covering plate 313 is a glass covering plate or a plastic covering plate, and the adhesive layer 315 is made of a pressure sensitive adhesive (PSA).

In an embodiment, the membrane wiring board 316 comprises an upper film layer 3162, a lower film layer 3163 and an intermediate film layer 3164, which are arranged in a stack form. A first circuit pattern (not shown) is formed on a bottom surface of the upper film layer 3162. The first circuit pattern comprises two upper contacts 31621. A second circuit pattern (not shown) is formed on a top surface of the lower film layer 3163. The second circuit pattern comprises two lower contacts 31631 corresponding to the plural upper contacts 31621. Each of the upper contacts 31621 and the corresponding lower contact 31631 are separated from each other by a spacing distance. Moreover, each of the upper contacts 31621 and the corresponding lower contact 31631 are collectively defined as a membrane switch 3161. For maintaining the spacing distance between each upper contact 31621 and the corresponding lower contact 31631, the intermediate film layer 3164 is arranged between the upper film layer 3162 and the lower film layer 3163. Preferably but not exclusively, each of the upper film layer 3162, the lower film layer 3163 and the intermediate film layer 3164 is made of polycarbonate (PC), polyethylene terephthalate (PET), polymethylmethacrylate (PMMA), polyurethane (PU) or polyimide (PI).

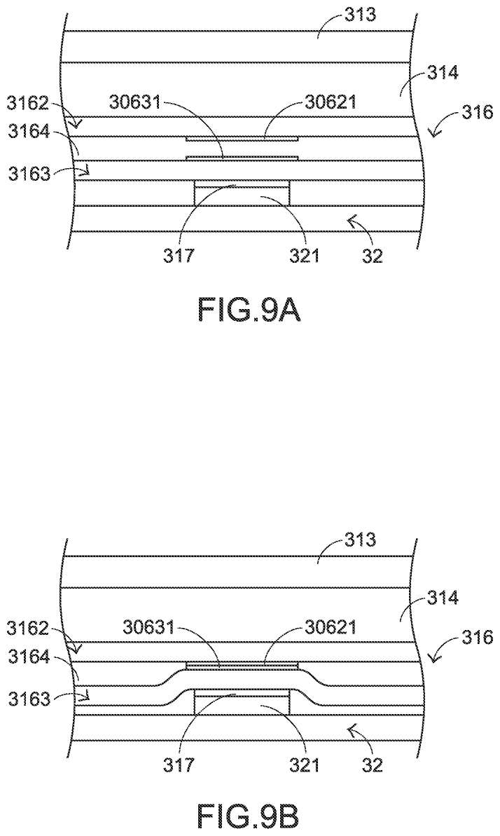

Hereinafter, the operations of the touch member 31 will be described with reference to FIGS. 9A and 9B. FIG. 9A is a schematic cross-sectional view illustrating a portion of the touchpad module as shown in FIG. 5, in which the touch member of the touchpad module is not pressed down. FIG. 9B is a schematic cross-sectional view illustrating a portion of the touchpad module as shown in FIG. 5, in which the touch member of the touchpad module is pressed down.

When the first end 311 of the touch member 31 is pressed down, the first end 311 of the touch member 31 is swung relative to the bracket 32 in the first direction D1. At the same time, the lower film layer 3163 of the membrane wiring board 316 is pushed, and the lower contacts 31631 of the lower film layer 3163 are contacted with the corresponding upper contacts 31621 of the upper film layer 3162. Consequently, the membrane switches 3161 are electrically conducted and triggered. When the first end 311 of the touch member 31 is not pressed down, the first end 311 of the touch member 31 is swung relative to the bracket 32 in a second direction D2 in response to the action of the supporting assembly 33. Consequently, the touch member 31 is returned to its original position.

In an embodiment, the touch member 31 further comprises two elastic triggering parts 317 corresponding to the two membrane switches 3161. The elastic triggering parts 317 are located under the lower film layer 3163. Moreover, two contacting parts 321 are disposed on the bracket 32. The two contacting parts 321 are aligned with the corresponding membrane switches 3161. Consequently, when the touch member 31 is pressed down, the membrane switches 3161 can be triggered more effectively and easily. Since the elastic triggering parts 317 are made of soft material, the use life of the membrane wiring board 316 can be effectively prolonged.

Preferably but not exclusively, the touchpad module 3 further comprises a haptic sensor 34. The haptic sensor 34 is arranged between the bracket 32 and the circuit board 314 of the touch member 31 and electrically connected with the circuit board 314. When the touch member 31 is pressed down and the membrane switches 3161 are triggered, the circuit board 314 drives the haptic sensor 34 to generate a haptic function. For example, the haptic sensor 34 is driven to generate vibration. Consequently, the operating tactile feel of the user is enhanced.

As mentioned above, the membrane wiring board 316 of the touchpad module 3 is used as a medium to be clicked, and the membrane wiring board 316 are equipped with the two membrane switches 3161 at the two opposite sides of the first end 311 of the touch member 31. Consequently, when the clicking function of the touchpad module 3 is enabled and any position of the touchpad module 3 is pressed down, the membrane switches 3161 can be effectively triggered. Moreover, the arrangement of the membrane wiring board 316 is helpful for the miniaturization of the touchpad module 3.

In the above embodiment, the membrane wiring board 316 of the touchpad module 3 comprises two membrane switches 3161. It is noted that the number of the membrane switches is not restricted. That is, the number of the membrane switches may be varied according to the practical requirements. Moreover, since the touchpad module 3 is a modular device, the touchpad module 3 can be fixed on the casing 41 of the computing device 4 through the fastening elements 39 (e.g., screws). In other words, the touchpad module 3 can be easily assembled in the computing device 4 by the worker in the production line.

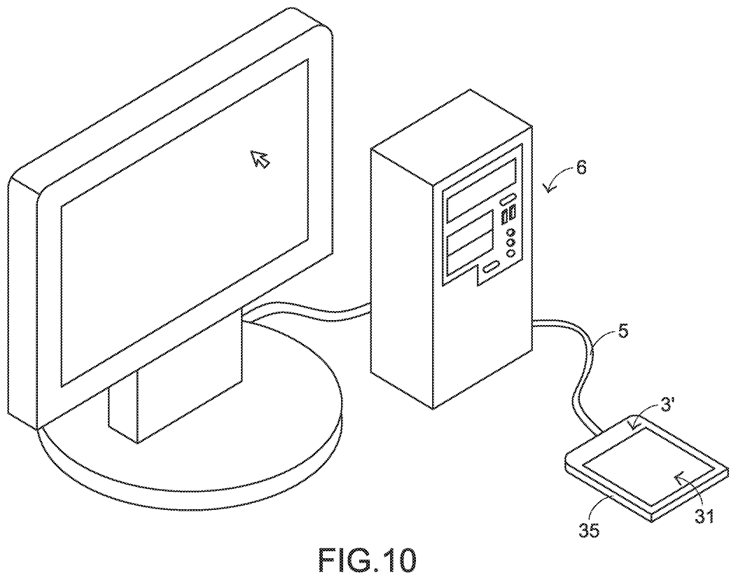

In the above embodiment, the touchpad module is installed in the computing device. It is noted that numerous modifications and alterations may be made while retaining the teachings of the invention. FIG. 10 schematically illustrates a touchpad module for a computing device according to another embodiment of the present invention. As shown in FIG. 10, the touchpad module 3′ is an external input device that is independent from the computing device. The touchpad module 3′ is in communication with a desktop computer 6 through a signal communication interface 5. For example, the signal communication interface 5 is a universal serial bus (USB). In comparison with the touchpad module 3 of the above embodiment, the touchpad module 3′ of this embodiment further comprises an outer shell 35. The outer shell 35 is an individual component for accommodating the touch member 31, the supporting assembly 33 and the bracket 32. The structures of the other components of the touchpad module 3′ are identical to those of the above embodiment, and are not redundantly described herein.

While the invention has been described in terms of what is presently considered to be the most practical and preferred embodiments, it is to be understood that the invention needs not be limited to the disclosed embodiments. On the contrary, it is intended to cover various modifications and similar arrangements included within the spirit and scope of the appended claims which are to be accorded with the broadest interpretation so as to encompass all such modifications and similar structures.

What is claimed is:

1. A touchpad module, comprising:
a bracket;
a touch member located over the bracket, and comprising a membrane wiring board and a circuit board, wherein the membrane wiring board comprises at least one membrane switch, and the at least one membrane switch is located at a first end of the touch member, wherein the circuit board is located over the membrane wiring board, and the circuit board issues a control signal in response to a touching behavior of a user on the touch member; and
a supporting assembly arranged between a second end of the touch member and the bracket, wherein while the first end of the touch member is pressed down, the first end of the touch member is swung relative to the bracket, so that the at least one membrane switch is triggered.

2. The touchpad module according to claim 1, wherein the touchpad module further comprises a haptic sensor between the bracket and the circuit board, wherein when the membrane switch is triggered, the haptic sensor generates a haptic function.

3. The touchpad module according to claim 2, wherein the haptic sensor and the membrane wiring board are electrically connected with the circuit board, wherein when the membrane switch is triggered, the circuit board drives the haptic sensor to generate the haptic function.

4. The touchpad module according to claim 1, wherein the membrane wiring board comprises an upper film layer and a lower film layer, wherein the upper film layer comprises at least one upper contact, and the lower film layer comprises at least one lower contact corresponding to the at least one upper contact, wherein each upper contact and the corresponding lower contact are separated from each other by a spacing distance and collectively defined as one of the at least one membrane switch.

5. The touchpad module according to claim 4, wherein the membrane wiring board further comprises an intermediate film layer between the upper film layer and the lower film layer, so that the each upper contact and the corresponding lower contact are separated from each other by the spacing distance.

6. The touchpad module according to claim 1, wherein the at least one membrane switch comprises two membrane switches, and the two membrane switches are located at two opposite sides of the touch member, respectively.

7. The touchpad module according to claim 1, wherein the touch member further comprises at least one elastic triggering part corresponding to the at least one membrane switch, and the at least one elastic triggering part is located under the membrane wiring board.

8. The touchpad module according to claim 1, wherein the touchpad module further comprises at least one contacting part, wherein the at least one contacting part is disposed on the bracket and aligned with the corresponding membrane switch.

9. The touchpad module according to claim 1, wherein if the touching behavior is a sliding behavior, the control signal is a displacement control signal, wherein if the touching behavior is a pressing behavior, the control signal is a switch control signal.

10. The touchpad module according to claim 1, wherein the touch member further comprises a covering plate, wherein the covering plate is located over the circuit board, and at least a portion of the covering plate is exposed outside a casing.

11. The touchpad module according to claim 10, wherein the covering plate is a glass covering plate or a plastic covering plate, and the covering plate and the circuit board are combined together through an adhesive layer.

12. The touchpad module according to claim 10, wherein the casing is included in a computing device, or the touchpad module contains the casing.

13. A computing device, comprising:
a casing, wherein an accommodation space is concavely formed in the casing;
a processor disposed within the casing; and
a touchpad module disposed within the accommodation space and electrically connected with the processor, wherein the touchpad module comprises:
a bracket;
a touch member located over the bracket, and comprising a membrane wiring board and a circuit board, wherein the membrane wiring board comprises at least one membrane switch, and the at least one membrane switch is located at a first end of the touch member, wherein the circuit board is located over the membrane wiring board, and the circuit board issues a control signal in response to a touching behavior of a user on the touch member; and
a supporting assembly arranged between a second end of the touch member and the bracket, wherein while the first end of the touch member is pressed down, the first end of the touch member is swung relative to the bracket, so that the at least one membrane switch is triggered.

14. The computing device according to claim 13, wherein the touchpad module further comprises a haptic sensor between the bracket and the circuit board, wherein when the membrane switch is triggered, the haptic sensor generates a haptic function.

15. The computing device according to claim 14, wherein the haptic sensor and the membrane wiring board are electrically connected with the circuit board, wherein when the membrane switch is triggered, the circuit board drives the haptic sensor to generate the haptic function.

16. The computing device according to claim 13, wherein the membrane wiring board comprises an upper film layer and a lower film layer, wherein the upper film layer comprises at least one upper contact, and the lower film layer comprises at least one lower contact corresponding to the at least one upper contact, wherein each upper contact and the corresponding lower contact are separated from each other by a spacing distance and collectively defined as one of the at least one membrane switch.

17. The computing device according to claim 13, wherein the at least one membrane switch comprises two membrane switches, and the two membrane switches are located at two opposite sides of the touch member, respectively.

18. The computing device according to claim 13, wherein the touch member further comprises at least one elastic triggering part corresponding to the at least one membrane switch, and the at least one elastic triggering part is located under the membrane wiring board.

19. The computing device according to claim 13, wherein the touchpad module further comprises at least one contacting part, wherein the at least one contacting part is disposed on the bracket and aligned with the corresponding membrane switch.

20. The computing device according to claim 13, wherein if the touching behavior is a sliding behavior, the control signal is a displacement control signal, wherein if the touching behavior is a pressing behavior, the control signal is a switch control signal.
